(19) United States
(12) Patent Application Publication
(10) Pub. No.: US 2026/0254558 A1
(43) Pub. Date: Aug. 27, 2026

(54) ERROR DETECTION AND CORRECTION IN CHANNEL STATE INFORMATION

(71) Applicant: Lenovo (Singapore) Pte. Limited, Singapore (SG)

(72) Inventors: Venkata Srinivas Kothapalli, Aurora, IL (US); Ahmed Hindy, Aurora, IL (US); Vahid Pourahmadi, München (DE); Vijay Nangia, Woodridge, IL (US)

(73) Assignee: Lenovo (Singapore) Pte. Limited, Singapore (SG)

(21) Appl. No.: 19/162,264

(22) PCT Filed: Mar. 7, 2024
(86) PCT No.: PCT/IB2024/052224

§ 371 Date: Sep. 4, 2025

Related U.S. Application Data
(60) Provisional application No. 63/489,128, filed on Mar. 8, 2023.

(51) Int. Cl. H04L 1/00

(52) U.S. Cl. CPC H04L 1/0026

(57) ABSTRACT

Various aspects of the present disclosure relate to methods, apparatuses, and systems that support error detection and correction in channel state information. For instance, implementations provide ways for utilizing attributes of channel feedback information (e.g., CSI) in encoding and decoding the channel feedback information. Implementations, for example, enable encoding and decoding of CSI where the CSI is represented using vectors such as singular vectors and/or eigenvectors. Further, implementations can utilize a channel covariance matrix for encoding and decoding CSI.

### RELATED APPLICATION

This application claims priority to U.S. Provisional Application Ser. No. 63/489,128 filed 8 Mar. 2023 entitled “ERROR DETECTION AND CORRECTION IN CHANNEL STATE INFORMATION,” the disclosure of which is incorporated by reference herein in its entirety.

### TECHNICAL FIELD

The present disclosure relates to wireless communications, and more specifically to channel feedback in wireless communications.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems provide ways for communicating channel feedback (e.g., channel state information (CSI)) between different entities in wireless communication networks. For instance, a UE can transmit CSI to a gNB indicating channel conditions of a wireless channel between the gNB and the UE, and the gNB can optimize (e.g., modify) various aspects of wireless communication based on the CSI.

### SUMMARY

The present disclosure relates to methods, apparatuses, and systems that support error detection and correction in channel state information. For instance, implementations provide ways for utilizing attributes of channel feedback information (e.g., CSI) in encoding and decoding the channel feedback information. Implementations, for example, enable encoding and decoding of CSI where the CSI is represented using vectors such as singular vectors and/or eigenvectors. Further, implementations can utilize a channel covariance matrix for encoding and decoding CSI.

By utilizing the described techniques signaling overhead for transmitting CSI can be reduced while increasing the accuracy and reliability with which CSI can be encoded, transmitted, and decoded.

Some implementations of the methods and apparatuses described herein may further include generating, at a first apparatus, encoded channel state information based at least in part on an encoding scheme including one or more of channel singular vectors, eigenvectors, or channel covariance matrix; transmitting, to a second apparatus, a first set of information including the encoded channel state information; and transmitting, to the second apparatus, an encoding indication identifying the encoding scheme.

Some implementations of the methods and apparatuses described herein may further include: generating the encoded channel state information using a machine learning model; receiving, from the second apparatus, an indication to provide information pertaining to the encoding scheme; and transmitting, based at least in part on the indication from the second apparatus, the encoding indication to the second apparatus.

Some implementations of the methods and apparatuses described herein may further include receiving a first set of information including a representation of one or more of a set of two or more vectors or a first matrix having a first characteristic; and generating, based at least in part on the first set of information, a second set of information, wherein the second set of information is generated via one or more of error detection or error correction and based at least in part on the first characteristic.

Further, in some implementations, the first set of information includes encoded channel state information, and wherein the encoded channel state information includes one or more of channel singular vectors, eigenvectors, or at least one channel covariance matrix; the first characteristic includes one or more properties of a matrix obtained from the set of vectors or a channel covariance matrix, and the one or more properties include at least one of orthonormality of the matrix, symmetry of the matrix, singular values of the matrix, or eigenvalues of the matrix; the method is performed at a first apparatus, and the method further includes: receiving the first set of information and a first set of parameters from a second apparatus, the first set of parameters including one or more of: encoding information for encoding performed at the second apparatus; one or more of size information or number information for one or more singular vectors; one or more of size information or number information for one or more eigenvectors; or one or more of size information or number information for a channel covariance matrix.

Some implementations of the methods and apparatuses described herein may further include: determining the first set of parameters based at least in part on one or more of predefined values, an indication received from the second apparatus, or an indication received from a third apparatus; generating a third set of information based at least in part on the first set of information and the first set of parameters, the third set of information including a second matrix including a number of rows and a number of columns; generating the third set of information using a machine learning model and the first set of parameters; generating the third set of information based at least in part on a second set of parameters, the second set of parameters including implementation information for the machine learning model.

Some implementations of the methods and apparatuses described herein may further include: receiving the second set of parameters from one or more of the second apparatus or a third apparatus; determining the second set of parameters in conjunction with training the machine learning model; the first set of information includes information about two or more of channel singular vectors or eigenvectors, and wherein generating the second set of information includes performing error detection on the second matrix of the third set of information including: decomposing the second matrix into a product of three matrices U, S, V using singular value decomposition; verifying, in the matrix S, whether the value of each element having its row index equal to its column index in the matrix S is equal to one; determining that the third set of information includes one or more errors if the value of at least one element having its row index same as its column index in the matrix S is not equal to one; determining that the third set of information does not include one or more errors if each element of the matrix S has a row index and a corresponding column index equal to one; and generating the second set of information wherein the second set of information is same as the third set of information.

Some implementations of the methods and apparatuses described herein may further include: performing an error correction procedure based at least in part on a determination that the third set of information includes one or more errors; the first set of information includes information about one or more of channel singular vectors or eigenvectors, and wherein generating the second set of information includes performing error detection on the second matrix of the third set of information including: determining an error check matrix by computing a product of two matrices, wherein a first matrix in the product includes a conjugate transpose of the second matrix generated in the third set of information and the second matrix in the product includes the matrix generated in the third set of information; determining that the third set of information includes one or more errors if the error check matrix is not equal to an identity matrix; determining that the third set of information does not include one or more errors if the error check matrix is equal to an identity matrix; and generating the second set of information wherein the second set of information is same as the third set of information.

Some implementations of the methods and apparatuses described herein may further include: performing an error correction procedure based at least in part on a determination that the third set of information includes one or more errors; the first set of information includes information about one or more of channel singular vectors or eigenvectors, and wherein the method further includes performing error correction on the second matrix of the third set of information including: decomposing the second matrix into a product of three matrices U, S, V using singular value decomposition; modifying the value of each element having its row index equal to its column index in the matrix S to be equal to one to generate a modified matrix S; generating a matrix from a product of the three matrices U, modified matrix S, and V; and indicating the generated matrix as the second set of information.

Further, in some implementations, the first set of information includes information about one or more of channel singular vectors or eigenvectors, and wherein the method further includes performing error correction on the second matrix of the third set of information including: decomposing the second matrix into a product of three matrices U, S, V using singular value decomposition; constructing a modified matrix U by keeping a first C columns in the matrix U and discarding other columns, where C is equal to the number of columns of the second matrix of the third set of information; generating a matrix from a product of the three matrices, the modified matrix U, matrix S, and V; and indicating the generated matrix as the second set of information; the first set of information includes information about one or more of channel singular vectors or eigenvectors, and wherein the method further includes performing error correction on the second matrix of the third set of information including: computing a polar decomposition of the second matrix and express the second matrix of the third set of information as a product of two matrices Q and P, in a same order; and indicating the matrix Q as the second set of information.

Further, in some implementations, the first set of information includes channel covariance matrix information, and wherein the method further includes performing error detection and correction including: if a conjugate transpose of the second matrix of the third set of information is not equal to the second matrix of the third set of information, replacing the second matrix of the third set of information with a matrix obtained by adding the conjugate transpose of the second matrix of the third set of information with the second matrix of the third set of information and divide a resultant matrix with two; computing an eigen decomposition of the matrix of the third set of information and expressing the second matrix of the third set of information as a product of three matrices, W, D, and conjugate transpose of W, in a same order; in the matrix D if each diagonal element having its row index equal to its column index is non-negative, determining that the second matrix of the third set of information does not include one or more errors; in the matrix D if a diagonal element having its row index equal to its column index is less than zero, replacing the diagonal element with zero; and indicating a matrix obtained from the product of the three matrices W, D, and conjugate transpose of W, in the same order, as the second set of information.

Further, in some implementations, the first set of information includes channel covariance matrix information, and wherein the method further includes performing error detection and correction including: if a conjugate transpose of the second matrix of the third set of information is not equal to the second matrix of the third set of information, replacing the second matrix of the third set of information with a matrix obtained by adding the conjugate transpose of the second matrix of the third set of information with the second matrix of the third set of information and dividing a resulting matrix with two; computing an eigen decomposition of the second matrix of the third set of information and express the second matrix of the third set of information as a product of three matrices, W, D, and a conjugate transpose of W, in a same order; in the matrix D if each diagonal element having its row index equal to its column index is non-negative, determining that the second matrix of the third set of information does not include one or more errors; in the matrix D if a diagonal element having its row index equal to its column index is less than zero, expressing the second matrix of the third set of information as product of two matrices Q and P using polar decomposition.

Some implementations of the methods and apparatuses described herein may further include: generating a further set of information by generating a matrix obtained by performing an addition of the second matrix of the third set of information and the matrix P obtained using polar decomposition, and dividing a result of the addition by two; and indicating the further set of information as the second set of information; transmitting, from a first apparatus to a second apparatus, an indication requesting information pertaining to an encoding scheme used to generate the first set of information; and receiving, from the second apparatus, an encoding indication identifying the encoding scheme; the encoding indication indicates that the encoding scheme is based on one or more of a vector representation or a matrix representation.

### BRIEF DESCRIPTION OF THE DRAWINGS

FIG. 1 illustrates an example of a wireless communications system that supports error detection and correction in channel state information in accordance with aspects of the present disclosure.

FIG. 2 illustrates a high-level structure of a two-sided model.

FIGS. 3 and 4 illustrate examples of block diagrams of devices that support error detection and correction in channel state information in accordance with aspects of the present disclosure.

FIGS. 5 through 8 illustrate flowcharts of methods that support error detection and correction in channel state information in accordance with aspects of the present disclosure.

### DETAILED DESCRIPTION

In wireless communications systems, wireless feedback information such as CSI can be utilized to optimize various aspects of wireless communication in wireless networks. For instance, a UE can transmit CSI to a gNB indicating attributes of a downlink channel between the gNB and the UE, and the UE can perform actions to attempt to optimize downlink signal quality between the gNB and the UE based on information in the CSI. While such wireless feedback information can be useful for controlling aspects of wireless communication, generating and communicating wireless feedback information can be prone to errors introduced across a wireless medium and can consume significant processing and signaling overhead.

Accordingly, techniques have been introduced to apply data compression to wireless feedback information to reduce data size and to attempt to mitigate errors that may be introduced across a wireless medium. For instance, some techniques utilize machine learning models (e.g., artificial intelligence models) to encode and decode wireless feedback information. Such machine learning techniques, however, may encounter a number of challenges. For instance, some machine learning techniques are prone to encoding and/or decoding errors that may reduce the reliability of wireless feedback information. Further, attributes of a wireless channel may introduce errors (e.g., noise) into encoded feedback information such that when decoded, the decoded feedback information may not match the original encoded feedback information. Still further, an encoder model (e.g., an encoder neural network) at an encoding device such as a UE may be mismatched with a decoder model (e.g., a decoder neural network) at a decoding device such as a gNB. This mismatch may result in inaccurate decoding of encoded feedback information, such as where the encoder model was trained on different training data than the decoder model.

Accordingly, this disclosure provides for techniques that support error detection and correction in channel state information. For instance, implementations provide ways for utilizing attributes of channel feedback information (e.g., CSI) in encoding and decoding the channel feedback information. Further, the described techniques are applicable to both single sided and two-sided machine learning models for encoding and decoding channel feedback information. For instance, implementations enable encoding and decoding of CSI where the CSI is represented using vectors such as singular vectors and/or eigenvectors. At an encoder, for instance, the vectors can be represented as a matrix which is encoded at an encoder device and the encoded matrix transmitted to a decoder device. The decoder device can utilize the described techniques to decode the encoded matrix and detect and correct data errors in the decoded matrix to obtain decoded CSI. Further, implementations can utilize a channel covariance matrix for encoding and decoding CSI. For instance, an encoder device can generate CSI as a channel covariance matrix, encode the channel covariance matrix, and transmit the encoded channel covariance matrix to a decoder device. The decoder device can decode the encoded channel covariance matrix and utilize the described techniques to perform error detection and error correction on the decoded channel covariance matrix.

In the discussion herein, the terms machine learning (ML), ML model, artificial intelligence (AI), AI model, and combinations thereof are used interchangeably. Further, in non-limiting implementations, an encoder may be implemented as an encoder neural network (NN) and a decoder may be implemented as a decoder NN.

Thus, by utilizing the described techniques signaling overhead for transmitting CSI can be reduced while increasing the accuracy and reliability with which CSI can be encoded, transmitted, and decoded.

Aspects of the present disclosure are described in the context of a wireless communications system. Aspects of the present disclosure are further illustrated and described with reference to device diagrams and flowcharts.

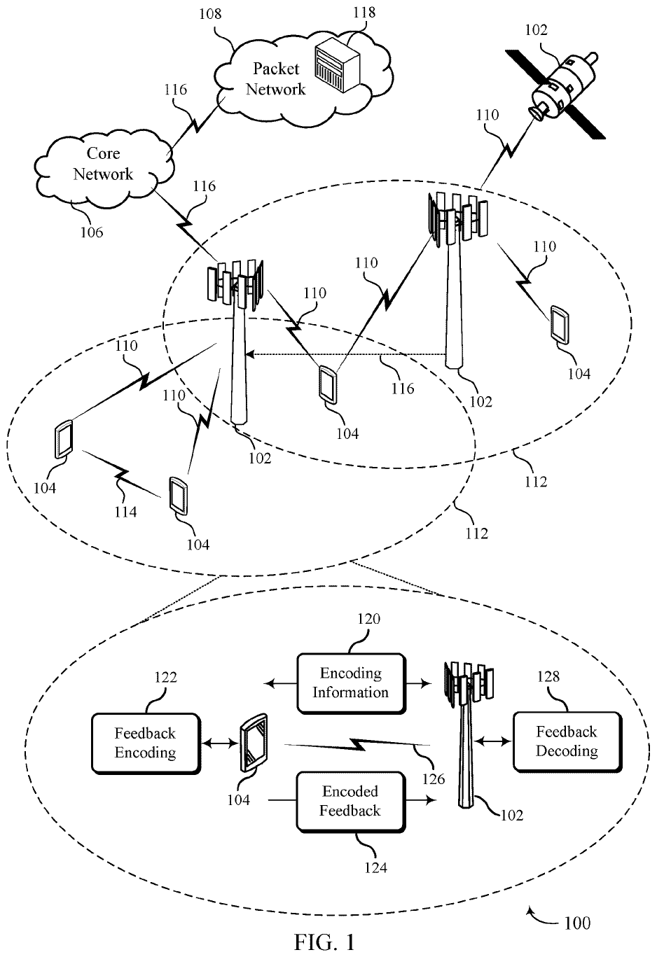

FIG. 1 illustrates an example of a wireless communications system 100 that supports error detection and correction in channel state information in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a RAN, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, MAC layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a PDU session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHz), FR4 (52.6 GHZ-114.25 GHZ), FR4a or FR4-1 (52.6 GHZ-71 GHz), and FR5 (114.25 GHZ-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for error detection and correction in channel state information, a network entity 102 and a UE 104 can exchange encoding information 120 that specifies various attributes of CSI encoding and/or decoding to be utilized by the network entity 102 and the UE 104. The encoding information 120 can be exchanged in various ways. For instance, the network entity 102 can transmit a request to the UE 104 for information on an encoding scheme to be utilized by the UE 104, and the UE 104 can return information on the encoding scheme. Alternatively or additionally, the UE 104 can transmit information to the network entity 102 about an encoding scheme utilized by the UE 104, such as independent of a query for such information from the network entity 102. In implementations, the encoding information 120 can indicate whether the UE 104 utilizes vectors (e.g., channel singular vectors, eigenvectors, etc.) and/or channel covariance matrices for CSI encoding.

The UE 104 performs feedback encoding 122 to generate encoded feedback 124, e.g., encoded CSI. The feedback encoding 122, for instance, is based at least in part on signal transmission 126 from the network entity 102 and received by the UE 104. In at least one implementation the signal transmission 126 includes some form of reference signal to enable the UE 104 to measurement channel attributes, such as CSI reference signal (CSI-RS). The feedback encoding 122, for instance, utilizes an encoding scheme identified in the encoding information 120. Accordingly, the network entity 102 performs feedback decoding 128 to decode the encoded feedback 124 and identify feedback information included in the encoded feedback. In implementations the feedback decoding 128 can be based at least in part on a decoding scheme identified in the encoding information 120. Various details of examples of the feedback decoding 128 are presented throughout this disclosure.

In wireless communication systems, feedback regarding wireless communication between nodes in a network (e.g., UEs and gNB) can be used to adapt attributes of wireless communication. For instance, consider a wireless network implementation with multiple antennas at a transmitting node (e.g., a UE) and multiple antennas at a receiving node, e.g., gNB. For example, consider a UE having r antennas and a base station (e.g., gNB) equipped with t antennas. A wireless channel between the gNB and the UE can have rt number of paths. In a downlink communication, where the gNB sends information to the UE, a discrete-time channel can be represented as a r×t dimensional complex-valued matrix H, with element hᵢⱼ of H denoting the complex-valued channel gain between i^{th} receive antenna and j^{th} transmit antenna, 1≤i≤r, 1≤j≤t.

Accordingly wireless channel gains and/or the channel matrix H can depend on the physical propagation medium and, due to the dynamic nature of the physical propagation medium, the wireless channel can be a time-varying channel. Further, the channel gains can depend on a frequency of operation. For instance, with a multicarrier waveform such as OFDM, the channel matrix can assume different values at different sub-carriers (e.g., frequencies) at a same instant of time. For example, the wireless channel matrix H can be stochastic in nature and varying across time, frequency, and spatial dimensions. By adapting a transmission technique as per the channel realization and/or pre-processing the information signal to be transmitted according to a current channel implementation, better throughput can be achieved over a communication link while making the link more reliable.

To achieve such an adaptive transmission and/or to implement pre-processing at a transmitter, CSI can be utilized at the transmitter. The transmitter, for instance, obtains the channel matrix H over a frequency range of operation (e.g., sub-carriers in scenarios of OFDM/multi-carrier waveforms) when a channel changes.

In implementations a receiver can estimate a channel through reference/pilot signals sent by a transmitter. Techniques for the transmitter to acquire channel information include for the receiver to provide CSI to the transmitter. For instance, in a downlink communication from a base station to a UE, the UE can estimate the downlink CSI using pilot/reference signals sent by the base station, and the UE can send estimated CSI to the base station. Further, in the uplink communication from the UE to the base station, the base station can estimate the CSI based on uplink reference/pilot signals from the UE and feed back the CSI to the UE. However, such feedback information can be overhead for the wireless network since it may not include user data. Thus, one challenge is to minimize the CSI overhead sent in the form of feedback from the UE while allowing the base station to acquire CSI of sufficient quality to enable the base station to optimize the communication over the link.

In implementations, when a receiver node (e.g., UE) estimates CSI, the receiver can use several techniques to compress the estimated CSI and feedback the compressed version of CSI to the transmitter, e.g., a base station. One technique for CSI compression for the purpose of feeding back CSI from a receiver to a transmitter is a two-sided machine learning model for CSI compression, e.g., an autoencoder.

In implementations an autoencoder (AE) can be a deep neural network (DNN) that can be used for dimensionality reduction. An AE can include two parts, an encoder E_{ω}, a DNN with learnable/trainable parameters denoted by ω, and a decoder D_{ψ}, another DNN with ψ as its set of trainable/learnable parameters. The encoder can learn a representation of an input data (e.g., encodes the input data) such that key attributes of the input data are captured as low-dimensional feature vector(s). The decoder can validate the encoding and assist the encoder in refining its encoding by attempting to regenerate the input data from the feature vectors generated by the encoder. Thus, the encoder and the decoder can be trained and developed together such that the data at the input to the encoder is attempted to be reconstructed accurately at the output of the decoder. Thus, the two neural networks, or the two models E_{ω} and D_{ψ} together can represent an autoencoder.

The following discussion presents an autoencoder based technique for CSI compression for a wireless network. For illustrative purposes, consider downlink communication from a base station to a UE. An AE can be trained to encode and decode channel matrices. For instance, a training data set can include a large number of wireless channel matrices (e.g., collected from the field, generated through simulations, etc.) and the AE can be trained such that the encoder generates a lower-dimensional latent representation of the input channel matrix and the decoder reconstructs the channel matrix from the latent representation generated by the encoder. After training, the encoder portion of the AE, E_{ω}, can be deployed at the UE and the decoder part of the AE, D_{ψ}, can be deployed at the base station. The UE can estimate the channel matrix using the reference/pilot signals received from the base station, encode the channel matrix using the encoder E_{ω}, and transmit the encoded output computed by the encoder over the wireless channel towards the base station. The base station, using the decoder D_{ψ}, can attempt to decode the channel matrix from the feature vectors received from the UE.

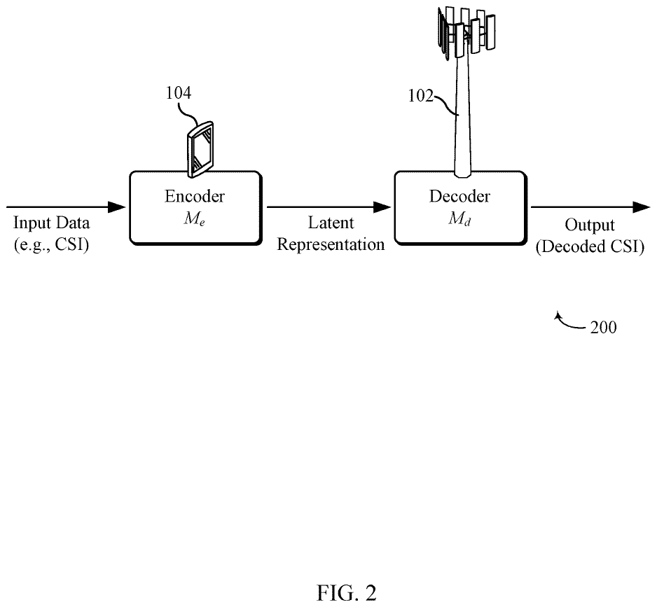

FIG. 2 illustrates a high-level structure of a two-sided model 200. The two-sided model 200 includes a with neural network-based UE and gNB sides referred to here as Mₑ (encoding model) and M_{d} (decoding model), respectively. The input of the model is based on channel measurement, e.g., CSI measurement.

In implementations the encoder (e.g., UE-side) of the model generates at least one latent representation of the model and quantizes the latent representations. The gNB receives the quantized data and can dequantize the quantized data, and uses the data as input to the decoder, e.g., gNB-side.

Another implementation of CSI compression and feedback using two sided AI/ML model is as follows: Instead of compressing and sending the channel matrix H, the singular vectors of the channel matrix H or the eigenvectors of HH* can be compressed and transmitted by training an AE to represent/compress a matrix including singular vectors and/or eigenvectors of a wireless channel. Such implementations can be utilized, such as since a channel matrix can be uniquely represented through its singular value decomposition/eigenvalue decomposition, the transmitter can have knowledge of the singular vectors and/or eigenvectors of the wireless channel (e.g., along with corresponding singular values/eigenvalues) to beamform the information signal, and the AE can compress the matrix consisting of the singular vectors and/or eigenvectors of the channel matrix, such as by utilizing properties of the singular vectors and/or eigenvectors.

In implementations, consider that a first node (e.g., UE) determines the singular vectors/eigenvectors of a wireless channel from a second node (e.g., gNB) toward the first node and is to compress the singular vectors/eigenvectors using an encoder of a two sided AI/ML model and send the output of the encoder towards the second node. The second node can receive the compressed CSI information sent by the first node and implement a decoder to reconstruct the singular vectors/eigenvectors from the received compressed CSI information. In some scenarios the singular vectors/eigenvectors decoded (e.g., reconstructed) by a decoder at the second node may not significantly correspond to singular vectors/eigenvectors at the input of the encoder. Multiple reasons may cause errors in such decoding. For instance, such decoding errors may occur due to errors in an AI/ML model. For instance, an AE can be a deep learning model (e.g., deep neural network (DNN)) and can have a non-zero probability of error. For instance, there can be a non-zero probability that the output of the AE (e.g., the output of the decoder) is not significantly similar that of the input, e.g., input of the encoder.

Errors may also occur due to wireless transmission. For instance, an encoder output (e.g., a feature vector computed by the encoder) may include floating-point values. The values can be quantized, mapped into bits, and then mapped to channel symbols before being transmitted over the channel from the first device to the second device. The channel, however, can corrupt/distort these symbols and thus cause noise at the input of the second device. Though channel coding and other protective mechanisms of a wireless network may attempt to minimize the effects of channel distortion and noise, there is nonetheless a non-zero probability that the input to the decoder is not significantly similar to the encoder output. For instance, while the decoder is to receive a feature vector computed by the encoder, it may receive a noisy/corrupted version of the feature vector due to distortions in the process of transmission over the wireless channel.

Errors may also occur due to mismatch between an encoder and a decoder. For instance, a wireless network in practice is a multi-user network in the sense that at a given time, multiple users are served by a base station (gNB) or an access point (AP). In a wireless cellular network, multiple UEs (e.g., UE₁, UE₂, . . . , UEᵤ) can be served by a gNB (e.g., Gᵢ) at a given time and consider downlink communication (from gNB to UEs) in such a network. Let E^{j} denote the encoder deployed at j^{th} UE, j=1, . . . , u, and let Dⁱ denote the decoder at the gNB Gᵢ. It might not be practical to ensure that all the encoders E^{j}, j=1, . . . , u are trained jointly with the decoder Dⁱ. This issue can be further accentuated by the notion that the UEs, being mobile, may move out from the coverage area of Gᵢ and get connected to another gNB (e.g., G_{i′}), where i≠i′. Thus, it may be practically infeasible to ensure that decoders employed at different UEs are trained jointly with and matched to the encoders employed at gNBs.

One possible solution to the issue discussed above is for a gNB to employ its own decoder for decoding/reconstructing the compressed CSI information received from different UEs in the network and the UEs in the network employ their own encoders for compressing the CSI information for feedback to the gNB. Further, encoders and decoders are not necessarily jointly developed and/or the encoders and decoders are developed and supplied by different vendors. Thus, implementations described herein can assist in such scenarios. The implementations, for instance, can provide for correcting decoder output such that errors at the output of the decoder are minimized, such as when the encoder and the decoder are not trained and developed jointly. The described techniques, for instance, allow UEs to employ off-the-shelf pretrained encoders such as supplied by any vendor, and gNBs to employ off-the-shelf pre-trained decoders such as supplied by any vendor. Further, the described techniques can ensure that the CSI information can be decoded with a minimum probability of errors at the decoder output. Thus, the described techniques can provide solutions to the issue of mismatch between encoder and decoder in two-sided AI/ML models used for CSI compression and feedback. Note that in some implementations described herein the discussion is presented with reference to downlink communication (e.g., communication from a gNB to a UE) for illustrative purposes. The described implementations, however, are equally applicable for uplink communication.

For purposes of portions of the following discussion, consider that for a length-t column vector a∈ [symbol] , or a row vector a∈ [symbol] , aᵢ denotes the i^{th} element of the vector. For a matrix Z∈ [symbol] , zᵢⱼ, Z_{i,1:t}, Z_{1:r,j} denote (i,j)^{th} element, i^{th} row, j^{th} column of matrix Z, respectively. Superscript T and superscript * denotes conjugate transpose (also known as Hermitian transpose) of a vector or a matrix. Thus, for a vector a, a^{T} denotes transpose of a, and a* denotes conjugate transpose (or, Hermitian) of a and the same holds true for a matrix A. Note that, for a real-valued vector a, conjugate transpose is equivalent to transpose, e.g., a*=a^{T} and similarly, for a real-valued matrix A, A*=A^{T}. Finally, ∥a∥_{F} denotes Frobenius norm of vector a.

In considering issues pertaining to errors in CSI feedback, such as using machine learning models, consider the following. For instance, consider wireless communication between a UE equipped with r antennas and a gNB equipped with t antennas. For the purpose of illustration, consider downlink communication where the gNB sends information to the UE over the wireless channel from gNB to UE, characterized by the matrix H∈ [symbol] . Channel state information is to be made available at the gNB through feedback from the UE. The UE can determine the channel matrix H based on pilot/reference signals transmitted by the gNB, and the UE may determine to compress and send the channel matrix H to the gNB and/or one of the following information derived from the channel matrix.

Singular vectors of the channel matrix: Singular vectors of H can be computed through singular value decomposition (SVD):

$$SVD ( H ) = {USV}^{*}$$

where U∈ [symbol] is a size r×r unitary matrix and V∈ [symbol] is a size t×t unitary matrix comprising of left and right singular vectors, respectively, of H and S is a diagonal matrix of size r×t where sᵢᵢ, 1≤i≥R, are the singular values of H, where s₁≥s₂≥ . . . ≥s_{R} and R=min(r,t). For convenience, we can skip the second subscript from sᵢᵢ and write sᵢᵢ as sᵢ.

The channel matrix can be uniquely represented through its singular value decomposition. To beamform the information signal towards the receiver (e.g., UE) in optimal manner, it can be helpful for the transmitter (e.g., gNB) to know the right-singular vectors of the forward channel along with the corresponding singular values. Thus, the UE can send information regarding matrix V including the right-singular vectors of H. In such scenarios, the UE can compress matrix V using its encoder and transmit a low-dimensional latent representation of V produced by the encoder to the gNB. In implementations, the input to the encoder can be a square unitary matrix and the decoder at the gNB can reconstruct the matrix V, e.g., a square unitary matrix.

In some scenarios, such as depending on the relative strengths of the singular values, the UE may determine to send a few of the right-singular vectors but not all of them. In such scenarios the UE can input a set of orthonormal vectors (e.g., the selected few right-singular vectors) to the encoder. The decoder at the gNB can reconstruct/reproduce these set of orthonormal vectors.

Channel covariance matrix: The covariance matrix of the channel matrix, given by HH* or H*H, such as depending on whether r≤t or t≤r, can respectively, include information for the gNB to adapt its transmission towards the UE in an optimal manner. Note that the covariance matrix is Hermitian, meaning that HH*=(HH*)* (also, H+H=(H+H)*) and positive semi-definite matrix, which means that the eigenvalues of HH* (or H*H) are non-negative.

Eigenvectors of the channel matrix: According to some scenarios, assume r≤t. Eigenvectors of HH* can be determined from the eigen decomposition (ED) of matrix HH*:

$$ED ( {HH}^{*} ) = {WDW}^{*}$$

where W∈ [symbol] is an r×r matrix comprising of orthonormal column vectors, which are the eigenvectors of HH*, and D is a diagonal matrix of size r×r where dᵢᵢ, 1≤i≤r, are the eigenvalues of HH*, where d₁₁≥d₂₂≥ . . . ≥dᵣᵣ. For convenience, we will skip the second subscript from dᵢᵢ and write dᵢᵢ as dᵢ.

When t≤r

$$ED ( {H}^{*} H ) = {WDW}^{*}$$

where W∈ [symbol] is an t×t matrix comprising of orthonormal column vectors, which are the eigenvectors of H*H, and D is a diagonal matrix of size t×t where dᵢᵢ, 1≤i≤r, are the eigenvalues of H*H, where d₁₁≥d₂₂≥ . . . ≥dᵣᵣ. For convenience, we will skip the second subscript from dᵢᵢ and write dᵢᵢ as dᵢ.

The channel matrix can be represented through its eigen decomposition. Note that the matrix W can be a unitary matrix if HH* is positive semi-definite. For example, when the wireless MIMO channel corresponds to uncorrelated Rayleigh fading channel, where each element of H is a complex Gaussian random variable with zero mean and unit variance.

Consider scenarios where the UE is to send the right singular vectors of the channel matrix to the gNB by compressing the right singular matrix V and sending the compressed information to the gNB, and the CSI compression and feedback occurs using a two-sided AI/ML model. This can imply that the UE is equipped with an encoder and the gNB is equipped with a decoder.

Accordingly, the UE can estimate the channel matrix H and compute the SVD of H to determine the matrices U, S and V. To compress the right-singular vectors, the UE can provide matrix V as input to the encoder input. The encoder can compute a latent representation/feature vector corresponding to its input matrix V. The UE can transmit the latent representation/feature vector produced by the encoder to the gNB.

The gNB can receive the noisy (e.g., due to additive noise at the input of the gNB receiver) and possibly distorted (e.g., due to channel distortions) version of the latent representation/feature vector sent by the UE. The gNB can process the received signal to attempt to mitigate the degrading effects of channel distortion and additive noise (e.g., channel equalization, decoding of forward error correction, etc.) to attempt to recover the latent representation/feature vector sent by the UE. Note that the latent representation/feature vector that is reproduced/recovered at the gNB may or may not be substantially the same as the latent representation/feature vector at the output of the encoder at the UE.

According to scenarios, the gNB can provide the latent representation/feature vector as an input to its decoder to reconstruct the matrix V comprising of the right-singular vectors of H. The decoder at gNB can attempt to decode/reconstruct the matrix V and output a matrix C. When C=V this can indicate a successful decoding. However, when C≠V, the gNB may have erroneous knowledge about the channel and its transmission towards the UE may not be reliable.

In scenarios and using the process outlined above, the UE can send matrix V including the right singular vectors of the channel matrix or both the matrices U and V. Further, the UE can also send matrix W including eigenvectors of HH* and/or H* H, such as by using the above stated procedure(s). For scenarios where the CSI feedback is to correspond to the feedback of the channel covariance matrix, the UE can supply HH* or H* H (e.g., depending on whether r≤t or t≤r, respectively) to the encoder as input, and can send the low-dimensional latent vector representation obtained from the encoder to the gNB. The decoder at the gNB can then attempt to reproduce the covariance matrix from the low-dimensional latent vector input. Thus, when the CSI feedback corresponds to the channel covariance matrix, the output from the decoder can be a Hermitian positive semi-definite matrix, given by either HH* or H* H, such as depending on encoded data generated by the encoder at the UE.

Consider also scenarios where the CSI feedback includes UE compressing matrix V including right-singular vectors of H and sending the compressed information to a gNB, and the decoder at the gNB attempting to reproduce matrix V. The probability of C≠V may be higher if the encoder and the decoder are not trained together jointly. For example, in the Type 3 training of two-sided AI/ML models being discussed in 3GPP RAN1 meetings, the encoder and decoder may be trained separately at different locations. Further, the UE may be equipped with a decoder developed by a first vendor and the gNB may be equipped with encoder developed by a second, different vendor. This may result in mismatched and/or un-aired encoder-decoders, which may cause a higher probability of error in the decoder output, e.g., higher probability of C≠V.

Other causes of the output of decoder not being equal to an indicated matrix include the following. For instance, the possibility of latent representation/feature vector given at the input of the decoder not being the same as the latent representation/feature vector at the output of the encoder. Further, an AI/ML model can have inaccuracies resulting in non-zero probability of error. Thus, there can be a non-zero probability of error in the decoder output even when the channel distortions/noise is negligible and the encoder is matched with the decoder.

In portions of the discussion herein, CSI feedback is discussed in the context of a two-sided AI/ML model. CSI feedback, however, may be implemented using one-sided AI/ML models. For example, consider downlink communication in which a UE is to send the CSI information to the gNB. The UE may encode/compress the CSI information corresponding to either singular/eigenvectors of the channel or the channel covariance matrix without using an AI/ML model for encoding/compressing the CSI information. The UE may encode/compress the CSI information based on a non-AI/ML method and send the encoded/compressed CSI information to the gNB. The gNB may employ an AI/ML model to decode/decompress/reconstruct the CSI information based on the feedback from the UE. Such scenarios can be classified as CSI feedback using a one-sided AI/ML model. Note that the discussed issue of errors in the AI/ML model output can be applicable to such CSI feedback using a one-sided AI/ML model. Further, the proposed solutions can apply in scenarios where CSI feedback is carried out using a one-sided AI/ML model.

Accordingly, solutions are provided in this disclosure to implement error detection and correction based on exploiting properties of a matrix to be reconstructed/produced by a decoder, e.g., a decoder. For instance, in the context of CSI and based at least in part on whether the CSI feedback includes singular vectors, eigenvectors, or a covariance matrix, the implementations can be dynamically modified. For instance, the described implementations can be modified for the following: When CSI feedback includes singular vectors of H or eigenvectors of HH* or H* H; when CSI feedback includes channel covariance matrix HH* or H*H.

In implementations, error detection and error correction can be applied when CSI feedback includes singular vectors and/or eigenvectors. For instance, CSI information encoded (e.g., compressed) and sent by a UE towards a gNB and to be decoded at the gNB can be a matrix B∈ [symbol] , n₁≥n₂>1, where the columns of matrix B are either the right-singular vectors or eigenvectors. Hence, the column vectors of B are orthonormal vectors, e.g., each column vector of matrix B is orthogonal to every other column vector of matrix B and each column vector of matrix B has unit norm.

Thus, when the CSI feedback corresponds to more than one singular/eigenvectors, input to the encoder at the UE can be a matrix B∈ [symbol] , n₁≥n₂>1 with orthonormal column vectors (e.g., consisting of either right-singular vectors or eigenvectors) and the output from the decoder at the gNB can be the same matrix B. Note that in implementations, for the matrix B, n₁=n₂ when CSI feedback includes (and/or when it is determined to feedback) the right-singular vectors or the eigenvectors. Further, n₁>n₂ when the CSI feedback includes (and/or when it is determined to feedback) a few and more than one of the right-singular vectors and/or eigenvectors.

In implementations, when the CSI feedback corresponds to more than one singular/eigenvectors, output of a decoder at a gNB can be a complex-valued matrix of size n₁×n₂, n₁≥n₂>1, with orthonormal column vectors. Note that in implementations n₁=n₂ when CSI feedback includes the right-singular vectors or the eigenvectors and n₁>n₂ when the CSI feedback includes a few and more than one of the right-singular vectors or eigenvectors.

In implementations, let the number of right-singular vectors or eigenvectors that the UE is to compress and feedback to the gNB be equal to n₂, where n₂>1 and where the length of each of the vector is n₁>1. The UE can construct a matrix B by arranging the n₂ number of vectors each having a length of n₁ as column vectors B, compress matrix B using its encoder and transmits the latent representation/feature vector computed by the encoder corresponding to B towards the gNB. The gNB can input the received latent representation/feature vector to its decoder and the decoder can output a matrix C∈ [symbol] , n₁≥n₂>1. In implementations where C=B, this can indicate accurate CSI feedback and enable the gNB to have accurate channel knowledge. However, such as discussed before and due to various factors including channel distortions, problems with AI/ML models and mismatch between the encoder and the decoder can cause a non-zero probability that C≠B. Thus, the described implementations provide for error detection and error correction in decoder output, which can enable accurate representations of CSI to be obtained.

The following discussion presents details and implementations for algorithms that can utilize channel singular vectors and/or eigenvectors for error detection and correction, such as in CSI. Note that the various algorithms for error detection and error correction are interchangeable.

```
Algorithm 1: Error detection (ED) and error correction (EC) of decoder output, such as
when CSI feedback corresponds to singular vectors and/or eigenvectors:
Input: Decoder output C ϵ [symbol] , n₁ ≥ n₂ > 1
Error Detection
  (ED-1). SVD method: Compute the SVD of C
SVD(C) = USV*
In the matrix S, if all the diagonal elements, sᵢᵢ, i = 1, . . ., min{n₁, n₂}, are equal to 1
(e.g., unit value), then declare there is no error in the decoder output and stop. Otherwise declare
that decoder output is erroneous and perform error correction procedure.
  (ED-2). Unitary method: Compute C* C. If C* C is an identity matrix, e.g., if C* C = I, then
    declare there is no error in the decoder output and stop. Otherwise declare that decoder
    output is erroneous and apply an error correction procedure.
Error Correction
(EC-1). SVD Method:
a. Compute the SVD of C
SVD(C) = USV*
where U ϵ [symbol]  and V ϵ [symbol]  are unitary matrices and S is n₁ × n₂ matrix with its elements
having the following property: Sᵢᵢ = 0, for i ≠ j, 1 ≤ i ≤ n₁,1 ≤ j ≤ n₂ and sᵢᵢ, i =
1, . . ., min{n₁, n₂}, represents the i^{th} singular value of C.
  b. In the matrix S, make sᵢᵢ = 1, for i = 1, . . ., min{n₁, n₂}.
  c. Replace the decoder output matrix C with matrix [symbol]  ϵ [symbol] , where [symbol]  = USV*
(EC-2). PD Method:
  a. Compute the Polar Decomposition (PD) C
PD(C) = QP
where Q ϵ [symbol]  is a matrix with orthonormal columns and P ϵ [symbol]  is a Hermitian positive
semi-definite matrix
  b. Replace the decoder output matrix C with matrix [symbol]  ϵ [symbol] , where [symbol]  = Q.
In an alternative or additional implementation for error correction based on Singular
value decomposition (SVD):
(EC-1A). SVD Method for Error Correction
  a. Compute the SVD of C
SVD(C) = USV*
where U ϵ [symbol]  and V ϵ [symbol]  are unitary matrices and S is n₁ × n₂ matrix with its elements
having the following property: sii = 0, for i ≠ j, 1 ≤ i ≤ n₁, 1 ≤ j ≤ n₂ and sᵢᵢ, i =
1, . . ., min{n₁, n₂}, represents the i^{th} singular value of C.
  b. Replace the decoder output matrix C with matrix [symbol]  ϵ [symbol] , where [symbol]  =
U_{1:n}_{_{1,}}_{1:n}_{₂} V* and U_{1:n}_{_{1,}}_{1:n}_{₂} ϵ [symbol]  is the matrix containing the first n₂ columns of
matrix U. Note that the matrix U_{1:n}_{₁},_{1:n}_{₂} is constructed from the matrix U by taking
only the first n2 columns from the matrix U.
```

In implementations the technique EC-1A stated above can be performed additionally or alternatively to EC-1 SVD described above with reference to Algorithm 1. Consider further the following points regarding Algorithm 1. Two example techniques are described for error detection, ED-1 (e.g., unitary method) and ED-2, e.g., SVD method. For error detection, a single implementation can be performed, e.g., either ED-1 or ED-2.

In implementations techniques proposed for error correction include EC-1 (SVD method), EC-2 (PD method) and EC-1A (Alternative SVD method). For error correction, a single instance of one of these techniques can be implemented, e.g., either EC-1 or EC-2, or EC-1A. In implementations, a particular technique for error correction can be chosen independently of a technique chosen for error detection and vice versa. For example, the techniques chosen for error detection and error correction, respectively, can be ED-1 and EC-1/EC-1A, or ED-1 and EC-2, or ED-2 and EC-1/EC-1A, or ED-2 and EC-2.

To further elaborate regarding the flexibility of choosing procedures independently/separately for error detection and error correction, consider the following examples.

Detecting and Correcting Errors in Decoder Output Using ED-1 and EC-1 from Algorithm 1 (e.g., Error Detection Using ED-1 (SVD Method) and Error Correction Using EC-1 (SVD Method)):

```
Input: Decoder output C ϵ [symbol] , n₁ ≥ n₂
Compute the SVD of C
SVD(C) = USV*
where U ϵ [symbol]  and V ϵ [symbol]  are unitary matrices and S is n₁ × n₂ matrix with its elements
having the following property: sᵢᵢ = 0, for i ≠ j, 1 ≤ i ≤ n₁, 1 ≤ j ≤ n₂ and sᵢᵢ, i =
1, . . ., min{n₁, n₂}, represents the ith singular value of C.
(1) Error Detection
  (i) If any of the diagonal elements, sᵢᵢ, i = 1, . . ., min{n₁, n₂}, of S are not equal to 1
    (e.g., unit value), then declare that the decoder output is in error and apply the Error
    Correction procedure in Step (3). Otherwise, declare the decoder output is not in
    error and stop.
(2) Error Correction
(i) In the matrix S, make \tilde{s}ᵢᵢ = 1, for i = 1, . . ., min{n₁, n₂}.
(ii) Replace the decoder output matrix C with matrix [symbol]  ϵ [symbol] , where [symbol]  = USV*
```

Detecting and Correcting Errors in Decoder Output Using ED-2 and EC-1A from Algorithm 1 (e.g., Error Detection Using ED-2 (Unitary Method) and Error Correction Using EC-1A (Alternative SVD Method)):

```
Input: Decoder output C ϵ [symbol] , n₁ ≥ n₂
(1) Error Detection
  (i) Compute C* C. If C* C is an identity matrix, e.g., if C* C = I, then declare there is
    no error in the decoder output and stop.
Otherwise declare that decoder output is erroneous and go for the Error Correction procedure in
Step (2).
(2) Error Correction
  (i) Compute the SVD of C
SVD(C) = USV*
where U ϵ [symbol]  and V ϵ [symbol]  are unitary matrices and S is n₁ × n₂ matrix with its elements
having the following property: sᵢᵢ = 0, for i ≠ j, 1 ≤ i ≤ n₁, 1 ≤ j ≤ n₂ and sᵢᵢ, i =
1, . . ., min{n₁, n₂}, represents the i^{th} singular value of C.
  (ii) Replace the decoder output matrix C with matrix [symbol]  ϵ [symbol] , where [symbol]  =
U_{1:n}_{_{1,}}_{1:n}_{₂} V* and U_{1:n}_{_{1,}}_{1:n}_{₂} ϵ [symbol]  is the matrix containing the first n₂ columns
of matrix U.
```

Detecting and Correcting Errors in Decoder Output Using ED-2 and EC-2 from Algorithm 1 (e.g., Error Detection Using ED-2 (Unitary Method) and Error Correction Using EC-2 (PD Method)):

```
Input: Decoder output C ϵ [symbol] , n₁ ≥ n₂
Error Detection
  (i) Compute C* C. If C* C is an identity matrix, e.g., if C* C = I, then declare there is
    no error in the decoder output and stop.
Otherwise declare that decoder output is erroneous and go for the Error Correction procedure in
Step (2).
(1) Error Correction
  (i) Compute the Polar Decomposition (PD) C
PD(C) = QP
where Q ϵ [symbol]  is a matrix with orthonormal columns and P ϵ [symbol]  is a Hermitian positive
semi-definite matrix.
  (ii) Replace the decoder output matrix C with matrix [symbol]  ϵ [symbol] , where [symbol]  = Q .
```

Detecting and Correcting Errors in Decoder Output Using ED-1 and EC-2 from Algorithm 1 (e.g., Error Detection Using ED-1 (SVD Method) and Error Correction Using EC-2 (PD Method)):

```
Input: Decoder output C ϵ [symbol] , n₁ ≥ n₂
(1) Error Detection
  (i) Compute the SVD of C
SVD(C) = USV*
  (ii) If any of the diagonal elements, sii, i = 1, . . . , min{n1, n2}, of S are not equal to 1
    (e.g., unit value), then declare that the decoder output is in error and apply the
    Error Correction procedure in Step (2). Otherwise, declare the decoder output is
    not in error and stop.
(2) Error Correction
  (i) Compute the Polar Decomposition (PD) C
PD(C) = QP
where Q ϵ [symbol]  is a matrix with orthonormal columns and P ϵ [symbol]  is a Hermitian positive
semi-definite matrix.
```

(ii) Replace the decoder output matrix C with matrix Ĉ∈ [symbol] , where Ĉ=Q.

Implementations described herein further provide for error detection and correction using channel covariance feedback. For instance, consider scenarios where CSI feedback includes a channel covariance matrix and techniques can be applied for error detection and error correction in the decoder output. For channel H∈ [symbol] the channel covariance matrix is given by HH*∈ [symbol] when r≤t and H*H∈ [symbol] , when t≤r. In such scenarios the CSI information to be compressed and sent by the UE towards the gNB and subsequently decoded/reconstructed at the gNB, can be a matrix B∈ [symbol] , n=min(r,t), where matrix B=HH* when r≤t and B=H*H when t≤r. Further, B is a Hermitian matrix and a positive semi-definite matrix. It is useful to note that: when matrix B is Hermitian, it is conjugate symmetric, e.g., B*=B, or equivalently,

$${b}_{ij}^{*} = {b}_{ij} ;$$

when matrix B is positive semi-definite, then all its eigenvalues are non-negative.

According to implementations note that positive semi-definite matrices are Hermitian (or, conjugate symmetric), but not all Hermitian matrices are positive semi-definite. Thus, positive semi-definiteness is a stronger condition.

According to implementations when CSI feedback corresponds to channel covariance matrix, output of the decoder at gNB would be a Hermitian (or, equivalently, conjugate symmetric) matrix and a positive semi-definite matrix. At time of reconstructing the CSI at the gNB using it decoder, let the decoder output matrix is denoted by C∈ [symbol] . In some scenarios C=B, which can indicate accurate CSI feedback, e.g., the channel covariance feedback. However, as discussed previously and due to various factors including channel distortions, imperfect AI/ML models and mismatch between the encoder and the decoder, there may be a non-zero probability that C≠B.

Accordingly, in the following two non-limiting example algorithms are proposed for error detection and error correction in the decoder output which can enable accurate CSI at the gNB. In implementations the error detection part is the same in both the algorithms but they can differ in how the error correction is achieved. For instance, Algorithm 2 performs error correction based on eigen decomposition and Algorithm 3 performs error correction based on polar decomposition.

```
  Algorithm 2: Error detection and correction of Decoder Output when CSI feedback
corresponds to channel covariance matrix — with Eigen Decomposition (ED) method for error
correction:
Input: Decoder output C ∈ [symbol] , n > 1
  (1) If C* = C, go to Step (3). If C* ≠ C, go to Step (2).
  (2)  $Replace C with \frac{1}{2} ( C + {C}^{*} ) .$
  (3) Compute the eigen decomposition of C:
        ED (C) = WDW*
      In the matrix D, if all the diagonal elements, dᵢᵢ, i = 1, ... , n, are non-negative, e.g., if dᵢᵢ ≥
      0, i = 1, ... , n, then stop. Otherwise go to Step (4).
  (4) Error Correction (eigenvalue decomposition method)
      (i) In the matrix D, replace negative values of dᵢᵢ, i = 1, ... , n, with zero; e.g.,
          In the matrix D, if dᵢᵢ < 0, then make dᵢᵢ = 0, for i = 1, ... , n.
      (ii) Replace the decoder output matrix C with matrix Ĉ ∈ [symbol] , where Ĉ = WDW*
```

```
  Algorithm 3: Error detection and correction of Decoder Output when CSI feedback
corresponds to channel covariance matrix — with Polar Decomposition (PD) method for error
correction:
Input: Decoder output C ∈ [symbol] , n > 1
  (1) If C* = C, go to Step (3). If C* ≠ C, go to Step (2).
  (2)  $Replace C with \frac{1}{2} ( C + {C}^{*} ) .$
  (3) Compute the eigen decomposition of C:
      ED(C) = WDW*
      In the matrix D, if all the diagonal elements, dᵢᵢ, i = 1, ... , n, are non-negative, e.g., if dᵢᵢ ≥
      0, i = 1, ... , n, then stop. Otherwise go to Step (4).
  (4) Error Correction (PD method)
      (i) Compute the Polar Decomposition (PD) of C
          PD(C) = QP
      where Q ∈ [symbol]  is a unitary matrix and P ∈ [symbol]  is a Hermitian positive semi-definite
      matrix.
      (ii)  $Replace the decoder output matrix C with matrix \hat{C} ∈ {ℂ}^{n \times n} , where \hat{C} = \frac{1}{2} ( C +$
          P)
```

Accordingly, implementations can be applied to perform a variety of different types and combinations of error detection and correction, including techniques that utilize various vector types and channel covariance feedback.

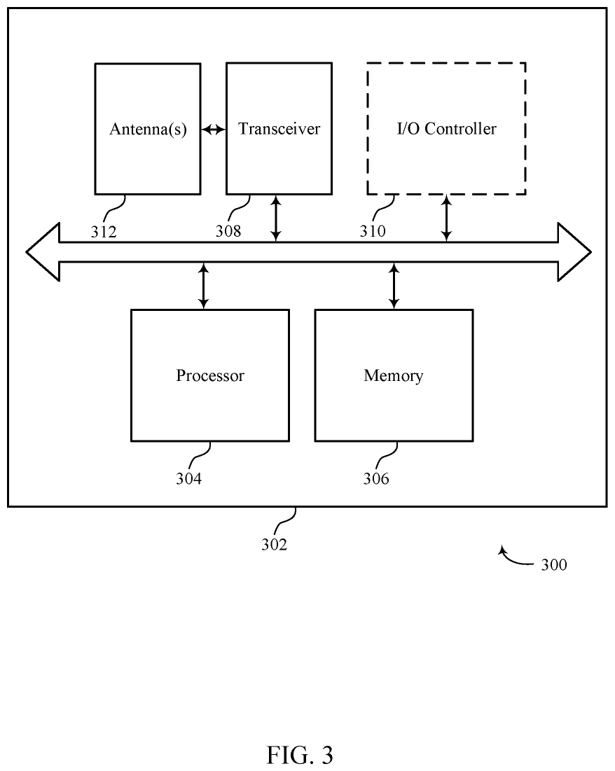

FIG. 3 illustrates an example of a block diagram 300 of a device 302 (e.g., an apparatus) that supports error detection and correction in channel state information in accordance with aspects of the present disclosure. The device 302 may be an example of UE 104 as described herein. The device 302 may support wireless communication with one or more network entities 102, UEs 104, or any combination thereof. The device 302 may include components for bi-directional communications including components for transmitting and receiving communications, such as a processor 304, a memory 306, a transceiver 308, and an I/O controller 310. These components may be in electronic communication or otherwise coupled (e.g., operatively, communicatively, functionally, electronically, electrically) via one or more interfaces (e.g., buses).

The processor 304, the memory 306, the transceiver 308, or various combinations thereof or various components thereof may be examples of means for performing various aspects of the present disclosure as described herein. For example, the processor 304, the memory 306, the transceiver 308, or various combinations or components thereof may support a method for performing one or more of the operations described herein.

In some implementations, the processor 304, the memory 306, the transceiver 308, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 304 and the memory 306 coupled with the processor 304 may be configured to perform one or more of the functions described herein (e.g., executing, by the processor 304, instructions stored in the memory 306). In the context of UE 104, for example, the transceiver 308 and the processor coupled 304 coupled to the transceiver 308 are configured to cause the UE 104 to perform the various described operations and/or combinations thereof.

For example, the processor 304 and/or the transceiver 308 may support wireless communication at the device 302 in accordance with examples as disclosed herein. For instance, the processor 304 and/or the transceiver 308 may be configured as and/or otherwise support a means to generate encoded channel state information based at least in part on an encoding scheme including one or more of channel singular vectors, eigenvectors, or channel covariance matrix; transmit, to a second apparatus, a first set of information including the encoded channel state information; and transmit, to the second apparatus, an encoding indication identifying the encoding scheme.

Further, in some implementations, the processor is configured to cause the first apparatus to generate the encoded channel state information using a machine learning model; the processor is configured to cause the first apparatus to: receive, from the second apparatus, an indication to provide information pertaining to the encoding scheme; and transmit, based at least in part on the indication from the second apparatus, the encoding indication to the second apparatus.

In a further example, the processor 304 and/or the transceiver 308 may support wireless communication at the device 302 in accordance with examples as disclosed herein. The processor 304 and/or the transceiver 308, for instance, may be configured as or otherwise support a means for generating, at a first apparatus, encoded channel state information based at least in part on an encoding scheme including one or more of channel singular vectors, eigenvectors, or channel covariance matrix; transmitting, to a second apparatus, a first set of information including the encoded channel state information; and transmitting, to the second apparatus, an encoding indication identifying the encoding scheme.

Further, in some implementations, processor 304 and/or the transceiver 308, for instance, may be configured as or otherwise support a means for generating the encoded channel state information using a machine learning model; receiving, from the second apparatus, an indication to provide information pertaining to the encoding scheme; and transmitting, based at least in part on the indication from the second apparatus, the encoding indication to the second apparatus.

The processor 304 of the device 302, such as a UE 104, may support wireless communication in accordance with examples as disclosed herein. The processor 304 includes at least one controller coupled with at least one memory, and the at least one controller is configured to and/or operable to cause the processor to generate encoded channel state information based at least in part on an encoding scheme comprising one or more of channel singular vectors, eigenvectors, or channel covariance matrix; transmit, to a second apparatus, a first set of information comprising the encoded channel state information; and transmit, to the second apparatus, an encoding indication identifying the encoding scheme. Further, the controller is configured to and/or operable to cause the processor to perform any of the various operations described herein, such as with reference to the device 302 and/or a UE 104.

The processor 304 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 304 may be configured to operate a memory array using a memory controller. In some other implementations, a memory controller may be integrated into the processor 304. The processor 304 may be configured to execute computer-readable instructions stored in a memory (e.g., the memory 306) to cause the device 302 to perform various functions of the present disclosure.

The memory 306 may include random access memory (RAM) and read-only memory (ROM). The memory 306 may store computer-readable, computer-executable code including instructions that, when executed by the processor 304 cause the device 302 to perform various functions described herein. The code may be stored in a non-transitory computer-readable medium such as system memory or another type of memory. In some implementations, the code may not be directly executable by the processor 304 but may cause a computer (e.g., when compiled and executed) to perform functions described herein. In some implementations, the memory 306 may include, among other things, a basic I/O system (BIOS) which may control basic hardware or software operation such as the interaction with peripheral components or devices.

The I/O controller 310 may manage input and output signals for the device 302. The I/O controller 310 may also manage peripherals not integrated into the device M02. In some implementations, the I/O controller 310 may represent a physical connection or port to an external peripheral. In some implementations, the I/O controller 310 may utilize an operating system such as iOS®, ANDROID®, MS-DOS®, MS-WINDOWS®, OS/2®, UNIX®, LINUX®, or another known operating system. In some implementations, the I/O controller 310 may be implemented as part of a processor, such as the processor M08. In some implementations, a user may interact with the device 302 via the I/O controller 310 or via hardware components controlled by the I/O controller 310.

In some implementations, the device 302 may include a single antenna 312. However, in some other implementations, the device 302 may have more than one antenna 312 (e.g., multiple antennas), including multiple antenna panels or antenna arrays, which may be capable of concurrently transmitting or receiving multiple wireless transmissions. The transceiver 308 may communicate bi-directionally, via the one or more antennas 312, wired, or wireless links as described herein. For example, the transceiver 308 may represent a wireless transceiver and may communicate bi-directionally with another wireless transceiver. The transceiver 308 may also include a modem to modulate the packets, to provide the modulated packets to one or more antennas 312 for transmission, and to demodulate packets received from the one or more antennas 312.

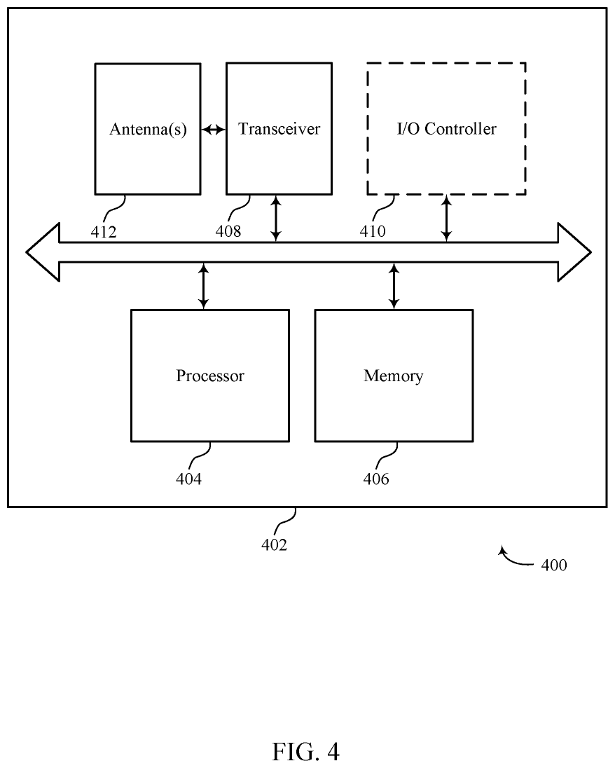

FIG. 4 illustrates an example of a block diagram 400 of a device 402 (e.g., an apparatus) that supports error detection and correction in channel state information in accordance with aspects of the present disclosure. The device 402 may be an example of a network entity 102 as described herein. The device 402 may support wireless communication with one or more network entities 102, UEs 104, or any combination thereof. The device 402 may include components for bi-directional communications including components for transmitting and receiving communications, such as a processor 404, a memory 406, a transceiver 408, and an I/O controller 410. These components may be in electronic communication or otherwise coupled (e.g., operatively, communicatively, functionally, electronically, electrically) via one or more interfaces (e.g., buses).

The processor 404, the memory 406, the transceiver 408, or various combinations thereof or various components thereof may be examples of means for performing various aspects of the present disclosure as described herein. For example, the processor 404, the memory 406, the transceiver 408, or various combinations or components thereof may support a method for performing one or more of the operations described herein.

In some implementations, the processor 404, the memory 406, the transceiver 408, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 404 and the memory 406 coupled with the processor 404 may be configured to perform one or more of the functions described herein (e.g., executing, by the processor 404, instructions stored in the memory 406). In the context of network entity 102, for example, the transceiver 408 and the processor 404 coupled to the transceiver 408 are configured to cause the network entity 102 to perform the various described operations and/or combinations thereof.

For example, the processor 404 and/or the transceiver 408 may support wireless communication at the device 402 in accordance with examples as disclosed herein. For instance, the processor 404 and/or the transceiver 408 may be configured as or otherwise support a means to receive a first set of information including a representation of one or more of a set of two or more vectors or a first matrix having a first characteristic; and generate, based at least in part on the first set of information, a second set of information, wherein the second set of information is generated via one or more of error detection or error correction and based at least in part on the first characteristic.

Further, in some implementations, the first set of information includes encoded channel state information, and wherein the encoded channel state information includes one or more of channel singular vectors, eigenvectors, or at least one channel covariance matrix; the first characteristic includes one or more properties of a matrix obtained from the set of vectors or a channel covariance matrix, and the one or more properties include at least one of orthonormality of the matrix, symmetry of the matrix, singular values of the matrix, or eigenvalues of the matrix; the processor is configured to cause the first apparatus to: receive the first set of information and a first set of parameters from a second apparatus, the first set of parameters including one or more of: encoding information for encoding performed at the second apparatus; one or more of size information or number information for one or more singular vectors; one or more of size information or number information for one or more eigenvectors; or one or more of size information or number information for a channel covariance matrix; the processor is configured to cause the first apparatus to determine the first set of parameters based at least in part on one or more of predefined values, an indication received from the second apparatus, or an indication received from a third apparatus.

Further, in some implementations, the processor is configured to cause the first apparatus to: generate a third set of information based at least in part on the first set of information and the first set of parameters, the third set of information including a second matrix including a number of rows and a number of columns; the processor is configured to cause the first apparatus to generate the third set of information using a machine learning model and the first set of parameters; the processor is configured to cause the first apparatus to generate the third set of information based at least in part on a second set of parameters, the second set of parameters including implementation information for the machine learning model; the processor is configured to cause the first apparatus to receive the second set of parameters from one or more of the second apparatus or the third apparatus.

Further, in some implementations, the processor is configured to cause the first apparatus to determine the second set of parameters in conjunction with training the machine learning model; the first set of information includes information about two or more of channel singular vectors or eigenvectors, and wherein to generate the second set of information, the processor is configured to cause the first apparatus to perform error detection on the second matrix of the third set of information including to: decompose the second matrix into a product of three matrices U, S, V using singular value decomposition; verify, in the matrix S, whether the value of each element having its row index equal to its column index in the matrix S is equal to one; determine that the third set of information includes one or more errors if the value of at least one element having its row index same as its column index in the matrix S is not equal to one; determine that the third set of information does not include one or more errors if each element of the matrix S has a row index and a corresponding column index equal to one; and generate the second set of information wherein the second set of information is equivalent to the third set of information

Further, in some implementations, the processor is configured to cause the first apparatus to perform an error correction procedure based at least in part on a determination that the third set of information includes one or more errors; the first set of information includes information about one or more of channel singular vectors or eigenvectors, and wherein to generate the second set of information, the processor is configured to cause the first apparatus to perform error detection on the second matrix of the third set of information including to: determine an error check matrix by computing a product of two matrices, wherein a first matrix in the product includes a conjugate transpose of the second matrix generated in the third set of information and the second matrix in the product includes the matrix generated in the third set of information; determine that the third set of information includes one or more errors if the error check matrix is not equal to an identity matrix; determine that the third set of information does not include one or more errors if the error check matrix is equal to an identity matrix; and generate the second set of information, wherein the second set of information is equivalent to the third set of information.

Further, in some implementations, the processor is configured to cause the first apparatus to perform an error correction procedure based at least in part on a determination that the third set of information includes one or more errors; the first set of information includes information about one or more of channel singular vectors or eigenvectors, and wherein the processor is configured to cause the first apparatus to perform error correction on the second matrix of the third set of information including to: decompose the second matrix into a product of three matrices U, S, V using singular value decomposition; modify the value of each element having its row index equal to its column index in the matrix S to be equal to one to generate a modified matrix S; generate a matrix from a product of the three matrices U, modified matrix S, and V; and indicate the generated matrix as the second set of information.

Further, in some implementations, the first set of information includes information about one or more of channel singular vectors or eigenvectors, and wherein the processor is configured to cause the first apparatus to perform error correction on the second matrix of the third set of information including to: decompose the second matrix into a product of three matrices U, S, V using singular value decomposition; construct a modified matrix U by keeping a first C columns in the matrix U and discarding other columns, where C is equal to the number of columns of the second matrix of the third set of information; generate a matrix from a product of the three matrices, the modified matrix U, matrix S, and V; and indicate the generated matrix as the second set of information.

Further, in some implementations, the first set of information includes information about one or more of channel singular vectors or eigenvectors, and wherein the processor is configured to cause the first apparatus to perform error correction on the second matrix of the third set of information including to: compute a polar decomposition of the second matrix and express the second matrix of the third set of information as a product of two matrices Q and P, in a same order; and indicate the matrix Q as the second set of information; the first set of information includes channel covariance matrix information, and wherein the processor is configured to cause the first apparatus to perform error detection and correction including to: if a conjugate transpose of the second matrix of the third set of information is not equal to the second matrix of the third set of information, replace the second matrix of the third set of information with a matrix obtained by adding the conjugate transpose of the second matrix of the third set of information with the second matrix of the third set of information and divide a resultant matrix with two; compute an eigen decomposition of the matrix of the third set of information and express the second matrix of the third set of information as a product of three matrices, W, D, and conjugate transpose of W, in a same order; in the matrix D if each diagonal element having its row index equal to its column index is non-negative, determine that the second matrix of the third set of information does not include one or more errors; in the matrix D, if a diagonal element having its row index equal to its column index is less than zero, replace the diagonal element with zero; and indicate a matrix obtained from the product of the three matrices W, D, and conjugate transpose of W, in the same order, as the second set of information.

Further, in some implementations, the first set of information includes channel covariance matrix information, and wherein the processor is configured to cause the first apparatus to perform error detection and correction including to: if a conjugate transpose of the second matrix of the third set of information is not equal to the second matrix of the third set of information, replace the second matrix of the third set of information with a matrix obtained by adding the conjugate transpose of the second matrix of the third set of information with the second matrix of the third set of information and divide a resulting matrix with two; compute an eigen decomposition of the second matrix of the third set of information and express the second matrix of the third set of information as a product of three matrices, W, D, and conjugate transpose of W, in a same order; in the matrix D if each diagonal element having its row index equal to its column index is non-negative, determine that the second matrix of the third set of information does not include one or more errors; in the matrix D if a diagonal element having its row index equal to its column index is less than zero, express the second matrix of the third set of information as product of two matrices Q and P using polar decomposition; generate a further set of information by generating a matrix obtained by performing an addition of the second matrix of the third set of information and the matrix P obtained using polar decomposition, and dividing a result of the addition by two; and indicate the further set of information as the second set of information.

Further, in some implementations, the processor is configured to cause the first apparatus to: transmit, to a second apparatus, an indication requesting information pertaining to an encoding scheme used to generate the first set of information; and receive, from the second apparatus, an encoding indication identifying the encoding scheme; the encoding indication indicates that the encoding scheme is based on one or more of a vector representation or a matrix representation.

In a further example, the processor 404 and/or the transceiver 408 may support wireless communication at the device 402 in accordance with examples as disclosed herein. The processor 404 and/or the transceiver 408, for instance, may be configured as or otherwise support a means for receiving a first set of information including a representation of one or more of a set of two or more vectors or a first matrix having a first characteristic; and generating, based at least in part on the first set of information, a second set of information, wherein the second set of information is generated via one or more of error detection or error correction and based at least in part on the first characteristic and one or more of the set of two or more vectors or the first matrix.

Further, in some implementations, the first set of information includes encoded channel state information, and wherein the encoded channel state information includes one or more of channel singular vectors, eigenvectors, or at least one channel covariance matrix; the first characteristic includes one or more properties of a matrix obtained from the set of vectors or a channel covariance matrix, and the one or more properties include at least one of orthonormality of the matrix, symmetry of the matrix, singular values of the matrix, or eigenvalues of the matrix; the method is performed at a first apparatus, and the method further includes: receiving the first set of information and a first set of parameters from a second apparatus, the first set of parameters including one or more of: encoding information for encoding performed at the second apparatus; one or more of size information or number information for one or more singular vectors; one or more of size information or number information for one or more eigenvectors; or one or more of size information or number information for a channel covariance matrix.

Further, in some implementations, the processor 404 and/or the transceiver 408 may be configured as or otherwise support a means for determining the first set of parameters based at least in part on one or more of predefined values, an indication received from the second apparatus, or an indication received from a third apparatus; generating a third set of information based at least in part on the first set of information and the first set of parameters, the third set of information including a second matrix including a number of rows and a number of columns; generating the third set of information using a machine learning model and the first set of parameters; generating the third set of information based at least in part on a second set of parameters, the second set of parameters including implementation information for the machine learning model.

Further, in some implementations, the processor 404 and/or the transceiver 408 may be configured as or otherwise support a means for receiving the second set of parameters from one or more of the second apparatus or a third apparatus; determining the second set of parameters in conjunction with training the machine learning model; the first set of information includes information about two or more of channel singular vectors or eigenvectors, and wherein generating the second set of information includes performing error detection on the second matrix of the third set of information including: decomposing the second matrix into a product of three matrices U, S, V using singular value decomposition; verifying, in the matrix S, whether the value of each element having its row index equal to its column index in the matrix S is equal to one; determining that the third set of information includes one or more errors if the value of at least one element having its row index same as its column index in the matrix S is not equal to one; determining that the third set of information does not include one or more errors if each element of the matrix S has a row index and a corresponding column index equal to one; and generating the second set of information wherein the second set of information is same as the third set of information.

Further, in some implementations, the processor 404 and/or the transceiver 408 may be configured as or otherwise support a means for performing an error correction procedure based at least in part on a determination that the third set of information includes one or more errors; the first set of information includes information about one or more of channel singular vectors or eigenvectors, and wherein generating the second set of information includes performing error detection on the second matrix of the third set of information including: determining an error check matrix by computing a product of two matrices, wherein a first matrix in the product includes a conjugate transpose of the second matrix generated in the third set of information and the second matrix in the product includes the matrix generated in the third set of information; determining that the third set of information includes one or more errors if the error check matrix is not equal to an identity matrix; determining that the third set of information does not include one or more errors if the error check matrix is equal to an identity matrix; and generating the second set of information, wherein the second set of information is equivalent to the third set of information.

Further, in some implementations, the processor 404 and/or the transceiver 408 may be configured as or otherwise support a means for performing an error correction procedure based at least in part on a determination that the third set of information includes one or more errors; the first set of information includes information about one or more of channel singular vectors or eigenvectors, and wherein the method further includes performing error correction on the second matrix of the third set of information including: decomposing the second matrix into a product of three matrices U, S, V using singular value decomposition; modifying the value of each element having its row index equal to its column index in the matrix S to be equal to one to generate a modified matrix S; generating a matrix from a product of the three matrices U, modified matrix S, and V; and indicating the generated matrix as the second set of information.

Further, in some implementations, the first set of information includes information about one or more of channel singular vectors or eigenvectors, and wherein the method further includes performing error correction on the second matrix of the third set of information including: decomposing the second matrix into a product of three matrices U, S, V using singular value decomposition; constructing a modified matrix U by keeping a first C columns in the matrix U and discarding other columns, where C is equal to the number of columns of the second matrix of the third set of information; generating a matrix from a product of the three matrices, the modified matrix U, matrix S, and V; and indicating the generated matrix as the second set of information; the first set of information includes information about one or more of channel singular vectors or eigenvectors, and wherein the method further includes performing error correction on the second matrix of the third set of information including: computing a polar decomposition of the second matrix and express the second matrix of the third set of information as a product of two matrices Q and P, in a same order; and indicating the matrix Q as the second set of information.

Further, in some implementations, the first set of information includes channel covariance matrix information, and wherein the method further includes performing error detection and correction including: if a conjugate transpose of the second matrix of the third set of information is not equal to the second matrix of the third set of information, replacing the second matrix of the third set of information with a matrix obtained by adding the conjugate transpose of the second matrix of the third set of information with the second matrix of the third set of information and divide a resultant matrix with two; computing an eigen decomposition of the matrix of the third set of information and expressing the second matrix of the third set of information as a product of three matrices, W, D, and conjugate transpose of W, in a same order; in the matrix D if each diagonal element having its row index equal to its column index is non-negative, determining that the second matrix of the third set of information does not include one or more errors; in the matrix D if a diagonal element having its row index equal to its column index is less than zero, replacing the diagonal element with zero; and indicating a matrix obtained from the product of the three matrices W, D, and conjugate transpose of W, in the same order, as the second set of information.

Further, in some implementations, the first set of information includes channel covariance matrix information, and wherein the method further includes performing error detection and correction including: if a conjugate transpose of the second matrix of the third set of information is not equal to the second matrix of the third set of information, replacing the second matrix of the third set of information with a matrix obtained by adding the conjugate transpose of the second matrix of the third set of information with the second matrix of the third set of information and dividing a resulting matrix with two; computing an eigen decomposition of the second matrix of the third set of information and express the second matrix of the third set of information as a product of three matrices, W, D, and a conjugate transpose of W, in a same order; in the matrix D if each diagonal element having its row index equal to its column index is non-negative, determining that the second matrix of the third set of information does not include one or more errors; in the matrix D if a diagonal element having its row index equal to its column index is less than zero, expressing the second matrix of the third set of information as product of two matrices Q and P using polar decomposition.

Further, in some implementations, the processor 404 and/or the transceiver 408 may be configured as or otherwise support a means for generating a further set of information by generating a matrix obtained by performing an addition of the second matrix of the third set of information and the matrix P obtained using polar decomposition, and dividing a result of the addition by two; and indicating the further set of information as the second set of information; transmitting, from a first apparatus to a second apparatus, an indication requesting information pertaining to an encoding scheme used to generate the first set of information; and receiving, from the second apparatus, an encoding indication identifying the encoding scheme; the encoding indication indicates that the encoding scheme is based on one or more of a vector representation or a matrix representation.

The processor 404 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 404 may be configured to operate a memory array using a memory controller. In some other implementations, a memory controller may be integrated into the processor 404. The processor 404 may be configured to execute computer-readable instructions stored in a memory (e.g., the memory 406) to cause the device 402 to perform various functions of the present disclosure.

The memory 406 may include random access memory (RAM) and read-only memory (ROM). The memory 406 may store computer-readable, computer-executable code including instructions that, when executed by the processor 404 cause the device 402 to perform various functions described herein. The code may be stored in a non-transitory computer-readable medium such as system memory or another type of memory. In some implementations, the code may not be directly executable by the processor 404 but may cause a computer (e.g., when compiled and executed) to perform functions described herein. In some implementations, the memory 406 may include, among other things, a basic I/O system (BIOS) which may control basic hardware or software operation such as the interaction with peripheral components or devices.

The I/O controller 410 may manage input and output signals for the device 402. The I/O controller 410 may also manage peripherals not integrated into the device M02. In some implementations, the I/O controller 410 may represent a physical connection or port to an external peripheral. In some implementations, the I/O controller 410 may utilize an operating system such as iOS®, ANDROID®, MS-DOS®, MS-WINDOWS®, OS/2®, UNIX®, LINUX®, or another known operating system. In some implementations, the I/O controller 410 may be implemented as part of a processor, such as the processor M06. In some implementations, a user may interact with the device 402 via the I/O controller 410 or via hardware components controlled by the I/O controller 410.

In some implementations, the device 402 may include a single antenna 412. However, in some other implementations, the device 402 may have more than one antenna 412 (e.g., multiple antennas), including multiple antenna panels or antenna arrays, which may be capable of concurrently transmitting or receiving multiple wireless transmissions. The transceiver 408 may communicate bi-directionally, via the one or more antennas 412, wired, or wireless links as described herein. For example, the transceiver 408 may represent a wireless transceiver and may communicate bi-directionally with another wireless transceiver. The transceiver 408 may also include a modem to modulate the packets, to provide the modulated packets to one or more antennas 412 for transmission, and to demodulate packets received from the one or more antennas 412.

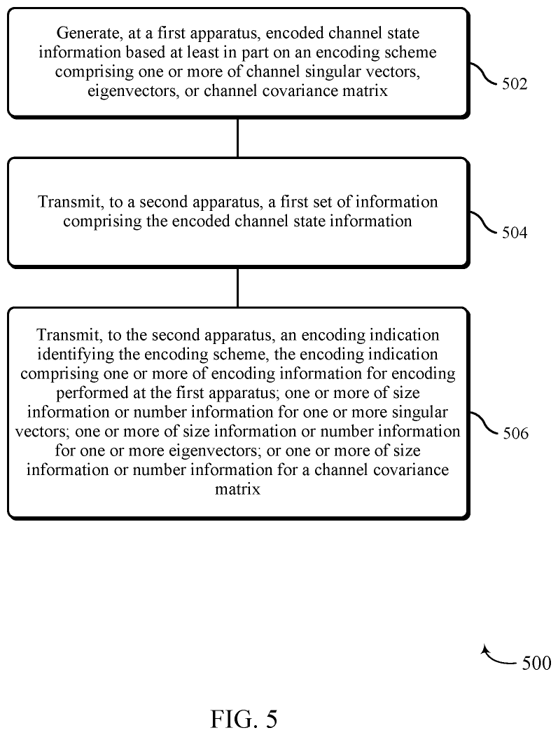

FIG. 5 illustrates a flowchart of a method 500 that supports error detection and correction in channel state information in accordance with aspects of the present disclosure. The operations of the method 500 may be implemented by a device or its components as described herein. For example, the operations of the method 500 may be performed by a UE 104 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 502, the method may include generating, at a first apparatus, encoded channel state information based at least in part on an encoding scheme comprising one or more of channel singular vectors, eigenvectors, or channel covariance matrix. The operations of 502 may be performed in accordance with examples as described herein. In some implementations, aspects of the operations of 502 may be performed by a device as described with reference to FIG. 1.

At 504, the method may include transmitting, to a second apparatus, a first set of information comprising the encoded channel state information. The operations of 504 may be performed in accordance with examples as described herein. In some implementations, aspects of the operations of 504 may be performed by a device as described with reference to FIG. 1.

At 506, the method may include transmitting, to the second apparatus, an encoding indication identifying the encoding scheme, the encoding indication including one or more of encoding information for encoding performed at the first apparatus; one or more of size information or number information for one or more singular vectors; one or more of size information or number information for one or more eigenvectors; or one or more of size information or number information for a channel covariance matrix. The operations of 506 may be performed in accordance with examples as described herein. In some implementations, aspects of the operations of 506 may be performed by a device as described with reference to FIG. 1.

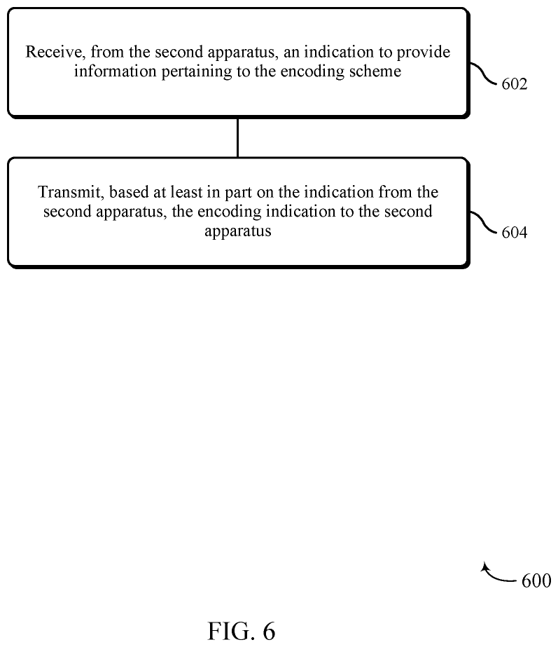

FIG. 6 illustrates a flowchart of a method 600 that supports error detection and correction in channel state information in accordance with aspects of the present disclosure. The operations of the method 600 may be implemented by a device or its components as described herein. For example, the operations of the method 600 may be performed by a UE 104 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 602, the method may include receiving, from the second apparatus, an indication to provide information pertaining to the encoding scheme. The operations of 602 may be performed in accordance with examples as described herein. In some implementations, aspects of the operations of 602 may be performed by a device as described with reference to FIG. 1.

At 604, the method may include transmitting, based at least in part on the indication from the second apparatus, the encoding indication to the second apparatus. The operations of 604 may be performed in accordance with examples as described herein. In some implementations, aspects of the operations of 604 may be performed by a device as described with reference to FIG. 1.

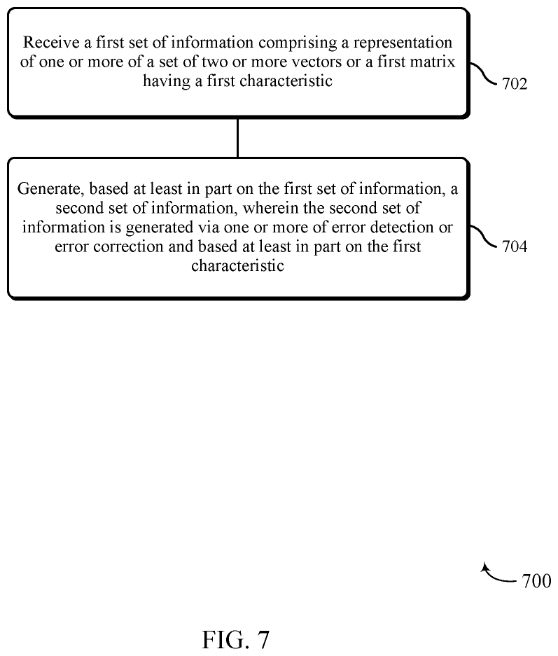

FIG. 7 illustrates a flowchart of a method 700 that supports error detection and correction in channel state information in accordance with aspects of the present disclosure. The operations of the method 700 may be implemented by a device or its components as described herein. For example, the operations of the method 700 may be performed by a network entity 102 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 702, the method may include receiving a first set of information comprising a representation of one or more of a set of two or more vectors or a first matrix having a first characteristic. The operations of 702 may be performed in accordance with examples as described herein. In some implementations, aspects of the operations of 702 may be performed by a device as described with reference to FIG. 1.

At 704, the method may include generating, based at least in part on the first set of information, a second set of information, wherein the second set of information is generated via one or more of error detection or error correction and based at least in part on the first characteristic. The operations of 704 may be performed in accordance with examples as described herein. In some implementations, aspects of the operations of 704 may be performed by a device as described with reference to FIG. 1.

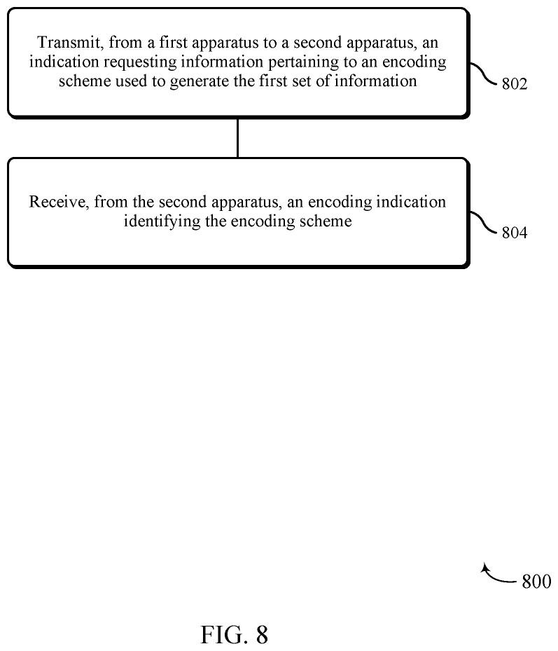

FIG. 8 illustrates a flowchart of a method 800 that supports error detection and correction in channel state information in accordance with aspects of the present disclosure. The operations of the method 800 may be implemented by a device or its components as described herein. For example, the operations of the method 800 may be performed by a network entity 102 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 802, the method may include transmitting, from a first apparatus to a second apparatus, an indication requesting information pertaining to an encoding scheme used to generate the first set of information. The operations of 802 may be performed in accordance with examples as described herein. In some implementations, aspects of the operations of 802 may be performed by a device as described with reference to FIG. 1.

At 804, the method may include receiving, from the second apparatus, an encoding indication identifying the encoding scheme. The operations of 804 may be performed in accordance with examples as described herein. In some implementations, aspects of the operations of 804 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network equipment for wireless communication, comprising:
at least one memory; and
at least one processor coupled with the at least one memory and operable to cause the network equipment to:
receive a first set of information comprising a representation of one or more of a set of two or more vectors or a first matrix having a first characteristic; and
generate, based at least in part on the first set of information, a second set of information, wherein the second set of information is generated via one or more of error detection or error correction and based at least in part on the first characteristic.

2. The network equipment of claim 1, wherein the first set of information comprises encoded channel state information, and wherein the encoded channel state information comprises one or more of channel singular vectors, eigenvectors, or at least one channel covariance matrix.

3. The network equipment of claim 1, wherein the first characteristic comprises one or more properties of a matrix obtained from the set of vectors or a channel covariance matrix, and the one or more properties comprise at least one of orthonormality of the matrix, symmetry of the matrix, singular values of the matrix, or eigenvalues of the matrix.

4. The network equipment of claim 1, wherein the at least one processor is operable to cause the network equipment to:
receive the first set of information and a first set of parameters from a second apparatus, the first set of parameters comprising one or more of:
encoding information for encoding performed at the second apparatus;
one or more of size information or number information for one or more singular vectors;
one or more of size information or number information for one or more eigenvectors; or
one or more of size information or number information for a channel covariance matrix.

5. The network equipment of claim 4, wherein the at least one processor is operable to cause the network equipment to determine the first set of parameters based at least in part on one or more of predefined values, an indication received from the second apparatus, or an indication received from a third apparatus.

6. The network equipment of claim 4, wherein the at least one processor is operable to cause the network equipment to:
generate a third set of information based at least in part on the first set of information and the first set of parameters, the third set of information comprising a second matrix comprising a number of rows and a number of columns.

7. The network equipment of claim 6, wherein the at least one processor is operable to cause the network equipment to generate the third set of information using a machine learning model and the first set of parameters.

8. The network equipment of claim 7, wherein the at least one processor is operable to cause the network equipment to generate the third set of information based at least in part on a second set of parameters, the second set of parameters comprising implementation information for the machine learning model.

9. The network equipment of claim 8, wherein the processor is operable to cause the first apparatus to receive the second set of parameters from one or more of the second apparatus or a third apparatus.

10. The network equipment of claim 8, wherein the at least one processor is operable to cause the network equipment to determine the second set of parameters in conjunction with training the machine learning model.

11. The network equipment of claim 6, wherein the first set of information comprises information about two or more of channel singular vectors or eigenvectors, and wherein to generate the second set of information, the at least one processor is operable to cause the network equipment to perform error detection on the second matrix of the third set of information including to:
decompose the second matrix into a product of three matrices U, S, V using singular value decomposition;
verify, in the matrix S, whether the value of each element having its row index equal to its column index in the matrix S is equal to one;
determine that the third set of information comprises one or more errors if the value of at least one element having its row index same as its column index in the matrix S is not equal to one;
determine that the third set of information does not comprise one or more errors if the value of each element of the matrix S, having its row index same as its column index, is equal to one; and
generate the second set of information wherein the second set of information is equivalent to the third set of information.

12. The network equipment of claim 11, wherein the at least one processor is operable to cause the network equipment to perform an error correction procedure based at least in part on a determination that the third set of information comprises one or more errors.

13. The network equipment of claim 6, wherein the first set of information comprises information about one or more of channel singular vectors or eigenvectors, and wherein to generate the second set of information, the at least one processor is operable to cause the network equipment to perform error detection on the second matrix of the third set of information including to:
determine an error check matrix by computing a product of two matrices, wherein a first matrix in the product comprises a conjugate transpose of the second matrix generated in the third set of information and the second matrix in the product comprises the matrix generated in the third set of information;
determine that the third set of information includes one or more errors if the error check matrix is not equal to an identity matrix;
determine that the third set of information does not include one or more errors if the error check matrix is equal to an identity matrix; and
generate the second set of information, wherein the second set of information is equivalent to the third set of information.

14. The network equipment of claim 13, wherein the at least one processor is operable to cause the network equipment to perform an error correction procedure based at least in part on a determination that the third set of information includes one or more errors.

15. The network equipment of claim 6, wherein the first set of information comprises information about one or more of channel singular vectors or eigenvectors, and wherein the at least one processor is operable to cause the network equipment to perform error correction on the second matrix of the third set of information including to:
decompose the second matrix into a product of three matrices U, S, V using singular value decomposition;
modify the value of each element having its row index equal to its column index in the matrix S to be equal to one to generate a modified matrix S;
generate a matrix from a product of the three matrices U, modified matrix S, and V; and
indicate the generated matrix as the second set of information.

16. A user equipment (UE) for wireless communication, comprising:
at least one memory; and
at least one processor coupled with the at least one memory and operable to cause the UE to:
generate encoded channel state information based at least in part on an encoding scheme comprising one or more of channel singular vectors, eigenvectors, or channel covariance matrix;
transmit, to a second apparatus, a first set of information comprising the encoded channel state information; and
transmit, to the second apparatus, an encoding indication identifying the encoding scheme.

17. The UE of claim 16, wherein the at least one processor is operable to cause the UE to generate the encoded channel state information using a machine learning model.

18. The UE of claim 16, wherein the at least one processor is operable to cause the UE to:
receive, from the second apparatus, an indication to provide information pertaining to the encoding scheme; and
transmit, based at least in part on the indication from the second apparatus, the encoding indication to the second apparatus.

19. (canceled)

20. A method performed by a user equipment (UE), the method comprising:
generating encoded channel state information based at least in part on an encoding scheme comprising one or more of channel singular vectors, eigenvectors, or channel covariance matrix;
transmitting, to a second apparatus, a first set of information comprising the encoded channel state information; and
transmitting, to the second apparatus, an encoding indication identifying the encoding scheme.

21. A method performed by a network equipment, the method comprising:
receiving a first set of information comprising a representation of one or more of a set of two or more vectors or a first matrix having a first characteristic; and
generating, based at least in part on the first set of information, a second set of information, wherein the second set of information is generated via one or more of error detection or error correction and based at least in part on the first characteristic.
